(19) United States
(12) Patent Application Publication
(10) Pub. No.: US 2024/0095814 A1
(43) Pub. Date: Mar. 21, 2024

(54) COMMODITY DISPLAY DEVICE, COMMODITY DISPLAY PROGRAM, AND COMMODITY DISPLAY METHOD

(71) Applicant: FROM JAPAN CO., LTD., Tokyo (JP)

(72) Inventor: Tomohiro KUNO, Tokyo (JP)

(21) Appl. No.: 17/768,076

(22) PCT Filed: Oct. 28, 2020
(86) PCT No.: PCT/JP2020/040386

§ 371 Date: Apr. 11, 2022

(30) Foreign Application Priority Data
Oct. 29, 2019 (JP) 2019-196700

(51) Int. Cl. G06Q 30/0601; G06F 3/0485

(52) U.S. Cl. CPC G06Q 30/0643; G06F 3/0485

(57) ABSTRACT

An object of the present invention is to provide a novel system that enables a plurality of products to be efficiently viewed. The present invention that achieves the aforementioned object is a product display device for displaying a plurality of products side by side on the same screen. The device includes a means for performing display processing on product information in order to display a list screen of the products, and a means for executing already-read processing to record an already-read state by a user for the product determined to be already read based on the display state of the product in the list screen shown to each user.

### TECHNICAL FIELD

The present invention relates to a product display device, a product display program, and a product display method, for displaying a plurality of products side by side on the same screen.

### BACKGROUND ART

In a recent information society, various types of information are available, and there is a need for technology for efficiently accessing information required by a user.

As literature related to such technology, for example, Patent Literature 1 is disclosed. Patent Literature 1 describes a display control device in which among a plurality of posts in the social media (social network services: SNS), a post that has been displayed and is unnecessary to be redisplayed is not displayed.

### CITATION LIST

### Patent Literature

Patent Literature 1: Japanese Patent Laid-Open No. 2014-157580

### SUMMARY OF INVENTION

### Technical Problem

According to the display control device described in Patent Literature 1, a post that is enough to be checked once is displayed only once and will never be displayed again. Therefore, a user can efficiently recheck posts having the high necessity to be redisplayed.

Meanwhile, viewing of information is not limited to the posts to the SNS. In particular, a technique for efficiently viewing products is needed in the case of viewing a large number of products to search for a desired one. For example, when a user checks new products under the same search condition or searches for a product by changing the search condition, there is a problem that products having been displayed before and products that are displayed for the first time are not distinguishable from each other. However, a technique for efficiently viewing a plurality of products has not existed conventionally.

In view of the above, an object of the present invention is to provide a novel system that enables a plurality of products to be viewed efficiently.

### Solution to Problem

In order to resolve the aforementioned problem, the present invention is a product display device for displaying a plurality of products side by side on the same screen. The device includes a means for performing display processing on product information to display a list screen of the products, and a means for executing already-read processing for recording an already-read state by a user for a product determined to be already read based on the display state of the product in the list screen shown to the user.

With this configuration, a displayed product is placed in an already-read state, so that an unread product that is not displayed and the already-read product are distinguishable from each other. Thereby, a user can check only unread products, or a seller of products and a website provider can research the tendency of products that are already read. Further, since a product is placed in an already-read state based on the display state in the list screen rather than whether or not a detailed screen of each product is checked, the user doesn't have to display the detailed screen of each product for making the product already-read. Therefore, an effect of a reduction in the communication amount and an effect of allowing a user to check products efficiently are expected.

In a preferable aspect of the present invention, the present invention further includes a means for performing display processing on the product information of an unread product in order to display the list screen containing the unread product not determined to be already read, while not displaying the already-read product determined to be already read.

With this configuration, it is possible to allow the user to check unread products efficiently.

Moreover, since the number of products to be displayed is reduced, it is possible to reduce the number of times of display updates, whereby an effect of load reduction on the processor can be expected.

In a preferable aspect of the present invention, the present invention further includes a means for performing display processing on the product information according to the determination result of an already-read state, in order to display an already-read product that is already read and an unread product that is not read in different modes.

With this configuration, since the user can distinguish the already-read products from unread products on the list screen of the products, it is possible to check the products efficiently.

In a preferable aspect of the present invention, the present invention further includes a means for receiving, from the user, and setting selection of display or non-display on the list screen of the already-read product determined to be already read, and a means for performing display processing on the product information of an unread product in order to display the list screen containing the unread product not determined to be already read when the non-display of the already-read product is set, while performing display processing on the product information in order to display the already-read product and the unread product distinguishably on the list screen when the display of the already-read product is set.

With this configuration, the user can select display or non-display of the already-read products by himself/herself to check the list screen. Thereby, the user can view a list screen corresponding to the own request in both the case where the user desires to check the already-read products as well and the case where the user desires to check only the unread products. Further, even when the user desires to check the already-read products as well since the already-read products and unread products are shown in different modes, the user can check the products efficiently.

In a preferable aspect of the present invention, the product is determined to be already read when the display area of the product is shown in a determination area within a display range on the screen.

With this configuration, an already-read determination can be performed by limiting the determination area within the display range of the screen. Thereby, when a determination area that is narrower than the display range is set, the number of products included in the determination area is reduced, so that a processing load in the already-read determination and the already-read processing is reduced. Further, by eliminating a portion that is less likely to be checked by the user although being displayed such as an end of the display range determination of an already-read state is performed more accurately within the range that is checked by the user.

In a preferable aspect of the present invention, the product is determined to be already read when a state where the display area of the product is shown in the determination area continues a predetermined time or longer.

With this configuration, it is possible to prevent a product that is shown only a short time and immediately excluded from the determination area so that it is less likely to be checked by the user, from being determined to be already read. Further, since the frequency of already-read processing is reduced, an effect of reducing the processing load can be expected.

In a preferable aspect of the present invention, the display area of the product is considered to be shown when a specific portion of the display area of the product falls within the determination area.

With this configuration, when a specific portion describing the information that is important for checking the product in the display area of the product, such as a product image or the like for example, does not fall in the determination area, it is possible to prevent the product from being determined to be already read. Accordingly, the determination of an already-read state is performed more accurately.

In a preferable aspect of the present invention, the display area of the product is considered to be shown in the determination area when, among a plurality of determination points set in the display area of the product or an outer periphery of the display area, a predetermined percentage of the determination points simultaneously fall within the determination area.

With this configuration, the product is determined to be already read when a certain portion of the product display area falls within the determination area. Therefore, it is possible to prevent the product from being determined to be already read when only a portion of the display area is displayed.

In a preferable aspect of the present invention, the display area of the product is considered to be shown in the determination area when, among a plurality of determination points set in the display area of the product or an outer periphery of the display area, all of the plurality of determination points of the product fall within the determination area.

With this configuration, the determination can be made based on the determination points that are set in the display area and the outer periphery including a certain range outside of the display area. Accordingly, by setting the determination points at points that must be checked by the user for determining that the product is already read, determination of an already-read state is performed more accurately. Further, by performing the determination of an already-read state based on the determination points rather than the entire display area, a processing load in already-read determination can be reduced.

In a preferable aspect of the present invention, the display area of the product is considered to be shown in the determination area when a state where each of the all of the plurality of determination points of the product falls within the determination area continues a predetermined time or longer.

With this configuration, the product is determined to be already read when all of the determination points set to respective portions of the display area of the product are shown a predetermined time or longer continuously.

In a preferable aspect of the present invention, the product is determined to be already read when a display area of the product passes through a determination line in the display range on a screen.

With this configuration, an already-read state of the product is determined according to passage through a determination line. Therefore, an effect of reducing a processing load related to already-read determination can be expected.

In a preferable aspect of the present invention, the display area of the product is considered to pass through the determination line when the display area of the product passes through the determination line in a direction toward the center of the display range on the screen.

With this configuration, it is possible to prevent the product from being determined to be already read when the display area of the products passes through the determination line in a direction that the display area moves away from the screen.

In a preferable aspect of the present invention, the display area of the product is considered to pass through the determination line when a specific portion of the display area of the product passes through the determination line.

With this configuration, it is possible to prevent the determination of an already-read state when a specific portion, of the display area of the product, describes the information that is important for checking the product in the display area of the product such as a product image or the like does not pass through the determination line. Therefore, the determination of an already-read state is performed more accurately.

In order to resolve the aforementioned problem, the present invention is a product display program for displaying a plurality of products side by side on the same screen. The program causes a computer to function as a display means for performing display processing on product information and transmitting the processing result to display a list screen of the products, and already-read processing means for executing already-read processing for the product determined to be already read in association with the user, based on the display state of the product shown in the list screen displayed to each user.

In order to resolve the aforementioned problem, the present invention is a product display method for displaying a plurality of products side by side on the same screen. The method causes a computer to perform the steps of performing display processing on product information and transmitting the processing result to display a list screen of the products and executing already-read processing for the product determined to be already read in association with the user, based on the display state of the product in the list screen displayed to each user.

### Advantageous Effect of Invention

According to the present invention, it is possible to provide a novel system that enables a plurality of products to be viewed efficiently.

### BRIEF DESCRIPTION OF DRAWINGS

FIG. 1 is a functional block diagram of a product display system according to an embodiment of the present invention.

FIG. 2 illustrates exemplary information stored in a database BD of the product display system according to the embodiment of the present invention.

FIG. 3 illustrates an example of a homepage screen shown on a product display device 1 of the product display system according to the embodiment of the present invention.

FIG. 4 illustrates views of an exemplary display of a list screen of the product display system when already-read products are shown in the embodiment of the present invention.

FIG. 5 illustrates an exemplary display of a list screen of the product display system when already-read products are shown in the embodiment of the present invention.

FIG. 6 illustrates an exemplary display of a list screen when already-read products are not shown in the embodiment of the present invention. It is a functional block diagram of the product display system.

FIG. 7 illustrates views of an example of determination points set in a product display area of the product display system according to the embodiment of the present invention.

FIG. 8 illustrates an example of determination when the determination of an already-read state is performed using a determination area according to the embodiment of the present invention.

FIG. 9 illustrates an example of determination when the determination of an already-read state is performed using a determination area according to the embodiment of the present invention.

FIG. 10 illustrates an example of the setting of a determination area in the embodiment of the present embodiment.

FIG. 11 illustrates views of an example of the setting of a determination area and determination lines in the embodiment of the present embodiment.

### DESCRIPTION OF EMBODIMENT

Hereinafter, a product display system having a product display device of the present invention will be described using the drawings. Note that the embodiment provided below is an example of the present invention. The present invention is not limited to the embodiment provided below, and various configurations can be adopted.

For example, in the present embodiment, a configuration, operation, and the like of a product display system having a product display device will be described. However, a method, a computer program, and the like having a similar configuration can also exhibit similar acts and effects. Further, a program may be stored on a storage medium. With the use of such a storage medium, it is possible to install a program into a computer for example. Here, a storage medium on which a program is stored may be a non-transitory storage medium such as a CD-ROM, for example.

A product in the present invention is one intended for sale, lending, and similar actions. That is, a product to be displayed in the present invention may be an article to be sold or lent or a service to be provided.

In the below description, a display range of a screen means a range that is actually shown on a screen as a display device viewed by a user. Further, a determination area is an area for determining an already-read state set in a predetermined portion within the display range, and a determination line is a line for determining an already-read state-provided within the display range.

On the other hand, in the present invention, a list screen means the entire screen in which a plurality of products are shown side by side and which is displayed to a user. The list screen has a different concept from the display range. That is, part of a list screen that falls within the display range is actually shown on the screen as a display device. In many examples, a user moves the display range by a scroll operation or the like to view the list screen and the like.

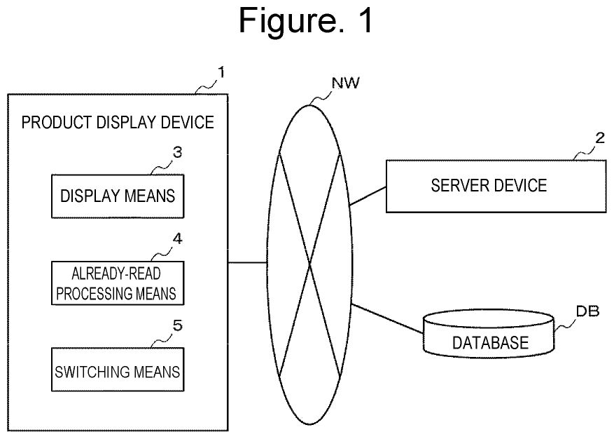

FIG. 1 is a functional block diagram of a product display system according to the present embodiment. The product display system of the present embodiment includes a product display device 1, a server device 2, a database DB, and a network NW. As the network NW, the Internet is expected.

The product display device 1 that displays a list screen to a user includes a display means 3, already-read processing means 4, and switching means 5, and is communicable with the server device 2 and the database DB over the network NW. The product display device 1 is a computer device used by a user and includes an arithmetic unit such as a central processing unit (CPU), the main storage device such as a random access memory (RAN), auxiliary storage devices such as a hard disk drive (HDD), a solid-state drive (SSD), and a flash memory. In addition, the product display device 1 also includes a connection means to the network NW, a display including a touch panel display, various input-output devices such as a microphone and a speaker, and the like.

In the present embodiment, the product display device 1 is stored therein a dedicated application (product display program) for allowing any computer to function as each means provided in the product display device 1. The product display device 1 may also store therein a web browser application for using web pages for viewing products, instead of or in addition to the product display program.

The display means 3 functions as a means for performing display processing on product information in order to display a list screen showing a plurality of products side by side. Specifically, the arithmetic unit of the product display device 1 performs display processing based on product information transmitted from the server device 2 or the database DB to function as the display means 3 of the present embodiment. As a result, a list screen is shown on the display of the product display device 1.

Further, the display means 3 of the present embodiment also functions as a means for performing display processing on product information of unread products in order not to display already-read products determined to be already read and to display a list screen including unread products not determined to be already read, and a means for performing display processing on the product information according to a result of the already-read determination in order to display the already-read products determined to be already read and the unread products not determined to be already read in different modes.

In the present embodiment, when non-display of the already-read products is set by the switching means 5, the display means 3 performs display processing on the product information of the unread products in order to display a list screen including the unread products. Meanwhile, when the display of the already-read products is set, the display means 3 performs display processing on the product information in order to display a list screen in which the already-read products and the unread products are shown in different modes. Note that when the display of the already-read products is set, the already-read products and the unread products may be shown in the same mode on the list screen.

The already-read processing means 4 functions as a means for executing already-read processing for recording an already-read state by a user for a product determined to be already read based on a display state of the product in the list screen displayed to the user. Specifically, the arithmetic unit of the product display device 1 functions as the already-read processing means 4 in the present embodiment by determining the display state of a product on the list screen and executing the already-read processing for storing the already-read state in the storage device of the product display device 1. It is also possible that server device 2 performs the already-read determination based on the display state of a product on the list screen, and according to the result, the already-read processing means 4 stores information that the product is already read by the user in the storage device of the product display device 1 or transmits the information to the server device 2 or the database DB.

The switching means 5 functions as a means for receiving, from a user, and setting selection of display or non-display on the list screen of already-read products determined to be already read. Specifically, according to selection by a user received via an input device such as a touch panel display of the product display device 1, the arithmetic unit of the product display device 1 stores, in the storage device of the product display device 1, the setting of display or non-display of already-read products on the list screen, or transmits it to the server device 2 or the database DB, to function as the switching means 5 in the present embodiment.

The server device 2 performs communication with the product display device 1 and the database DB over the network NW and performs processing for displaying a list screen on the product display device 1. As the server device 2, a general computer device having an arithmetic unit, a main storage device, auxiliary storage devices, and various input-output devices including a connection means to the network NW may be used.

In the present embodiment, the server device 2 transmits product information and the like stored in the database DB for displaying a list screen on the product display device 1 and receives information of an already-read state by a user from the product display device 1 and stores it in the database DB. Further, in the present embodiment, the arithmetic unit of the server device 2 performs processing to determine the contents to be displayed on a list screen and allows them to be in a state capable of being shown on the display of the product display device 1. In response to transmission of the processing result to the product display device 1, the display means 3 executes the display processing.

Note that part of the processing performed by each means of the product display device 1 may be performed by the server device 2, and the server device 2 may transmit the processing result to the product display device 1. For example, server device 2 may perform the determination of an already-read state as described above.

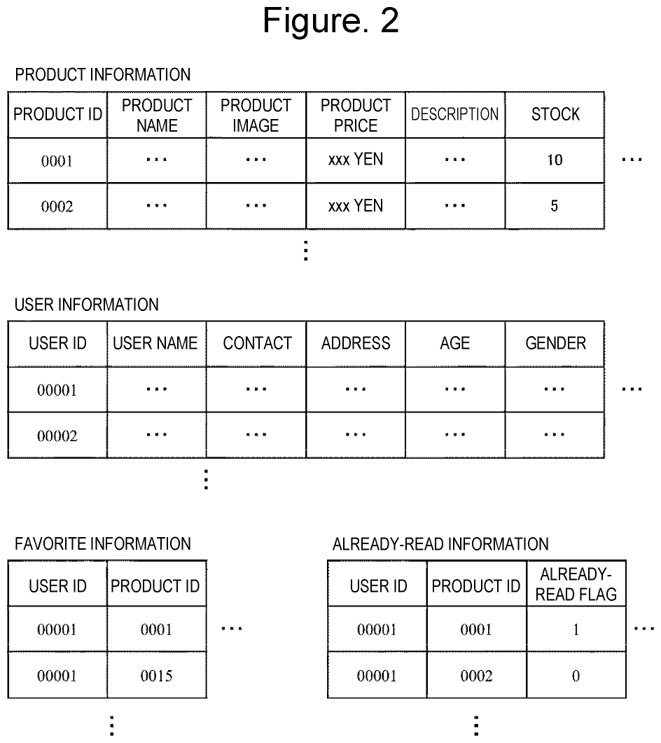

The database DB stores therein various types of information including product information. FIG. 2 illustrates an example of information stored in the database DB in the present embodiment. The database DB of the present embodiment stores product information, user information, favorite information, already-read information, and the like.

As product information, information such as a product ID that uniquely identifies a product, product name, product image, product price, description, and stock is stored for each product. In addition, information such as a category or a distributor of a product, manufacturer, and evaluation from users may also be stored as product information.

As user information, information such as a user ID that uniquely identifies a user, user name, contact information such as email address and telephone number, address that can be used as delivery destination and billing destination, age, gender, and the like of the user, is stored for each user. Registration of these types of information is not mandatory. Only part of the information may be registered with the database DB. Moreover, regarding the age of a user, for example, a rough age group such as teens or twenties may be registered. Furthermore, in the present embodiment, a user not registered as a user (not registered user information) can use the product display device 1.

Favorite information is information for saving the favorite products of each user. In the present embodiment, a favorite product of each user is specified by storing a user ID and a product ID of a product designated as a favorite product in association with each other, by an input from the user via the product display device 1. Note that a user and a favorite product may be stored in any form if they are associated with each other. For example, as an identifier for identifying a user, the database DB may store a character string or the like unique to the product display device 1 or a product display device program in association with a favorite product, instead of the user ID.

The following information is stored as already-read information: an identifier that identifies a user who viewed the product, the product ID, and an already-read flag. Here, while a user ID is used as an identifier that identifies a user in FIG. 2, as an identifier for identifying a user, a user ID can be used for a registered user (user whose user information exists), and a character string or the like unique to the product display device 1 or the product display device program can be used for a user whose registration is not confirmed.

Further, in the above description, it is assumed that an already-read flag is provided for each user and each product, and as a result of already-read processing, an already-read flag is set (becomes 1). However, the form of information indicating an already-read state is not limited. For example, only a product ID of an already-read product may be stored as already-read information. Alternatively, as already-read processing, the already-read processing means 4 may update the number of already-read times each time the condition for already-read determination is satisfied and store it in the database DB, and the database DB may store the number of already-read times of each product for each user, instead of an already-read flag. In that case, a product the number of already-read times is 0 is an unread product, and a product having 1 or larger is an already-read product.

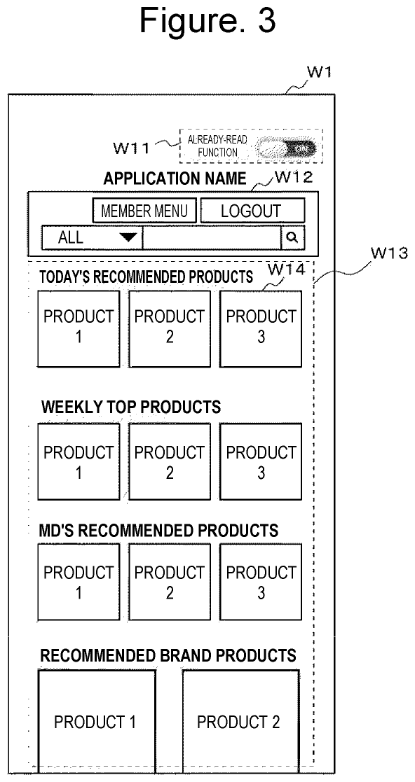

Hereinafter, an exemplary display of a list screen in the present embodiment will be described with reference to FIGS. 3 to 6. Note that in the drawings other than FIG. 3, a list screen has an already-read switching part and a product display area. However, a menu display part may always be shown on the screen as similar to FIG. 3. FIG. 3 illustrates an example of a homepage screen displayed on the product display device 1. The homepage screen includes an already-read switching part W11, a menu display part W12, and a product display part S13. In the product display part W13, a plurality of display areas W14 of respective products is shown side by side. Here, the product display part W13 of the homepage screen is also included in the list screen of the present invention.

When a search condition such as a category of a product or a keyword is input in W12, a communication means of the product display device 1 transmits the search condition to the server device 2 over the network NW. The server device 2 performs processing for extracting one matching the search condition from the product information stored in the database DB, and as a search result, transmits product information for displaying the extracted product on the list screen of the search results the product display device 1.

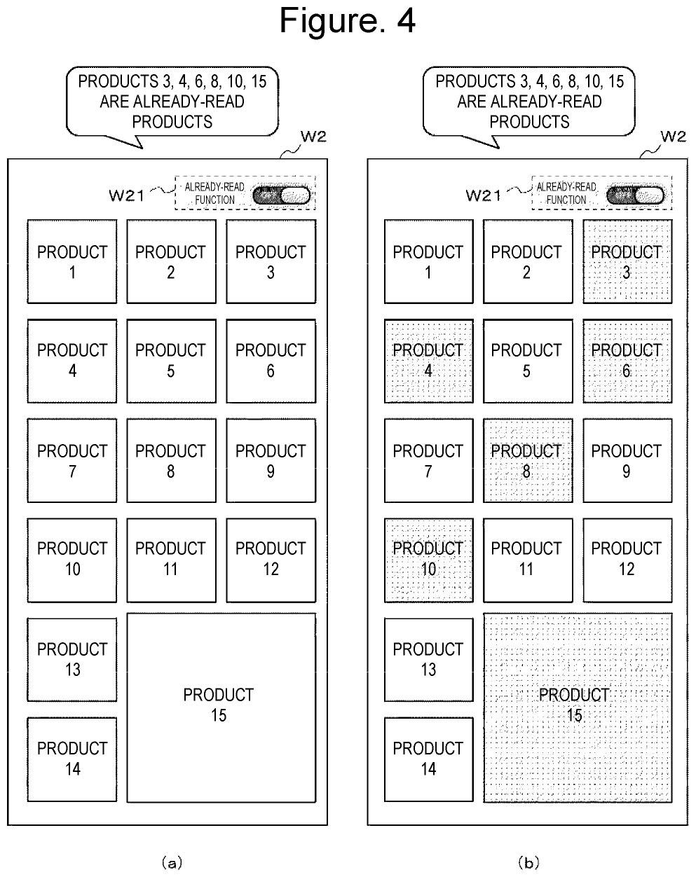

In the product display device 1, display processing is performed by the display means 3, and a list screen is shown on the display. FIG. 4 illustrates an exemplary display of a list screen when the display of already-read products is selected (when the already-read non-display function is OFF). The already-read switching part W21 is also shown on the list screen.

As described above, in the present embodiment, when the display of already-read products is selected, both the already-read products and unread products are shown, and when non-display of already-read products is selected, only unread products are shown. Here, in the present embodiment, already-read products, and unread products are shown in different modes as illustrated in FIG. 4 (b). However, already-read products and unread products may be shown in the same mode as illustrated in FIG. 4 (a).

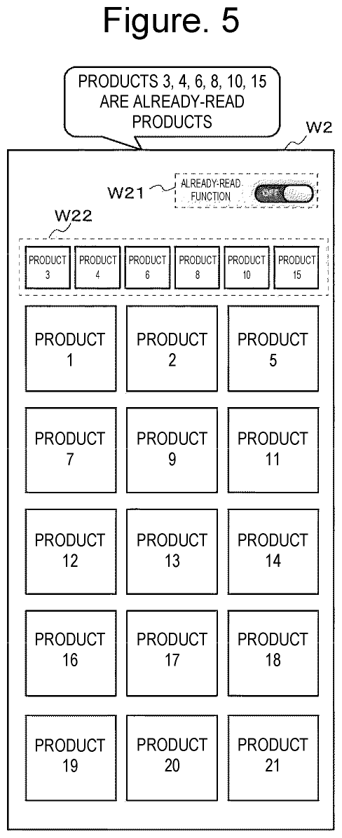

In FIG. 4(b), while a display area for an unread product is not processed particularly, a display area for an already-read product is colored. Further, as another mode, FIG. 5 illustrates an example in which the list screen includes the already-read product display part W22 for displaying already-read products, and in the already-read product display part W22, already-read products are shown in a display area that is smaller than that for unread products.

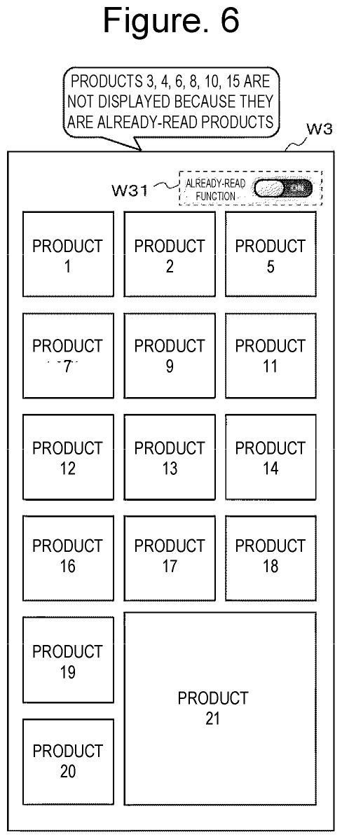

When the already-read switching part W1l or W21 is operated, the already-read processing means 4 accesses the server device 2 or the database DB to update the already-read information, and the switching means 5 switches the setting between display and non-display of the already-read products. The setting of display or non-display of already-read products may be stored in the storage means of the product display device or may be stored in the server device 2 or the database DB. FIG. 6 illustrates an exemplary display of a list screen when non-display of already-read products is selected (when the already-read non-display function is ON). In this case, already-read products are not shown. Instead, subsequent unread products are shown, so that a list screen containing unread products is displayed. In this example, products No. 3, 4, 6, 8, 10, and 15 are already-read products, and the other products are unread products.

As illustrated in FIGS. 3 to 6, in the list screen, the size of the display area for each product may differ from one another. For example, depending on the attribute such as an age group or gender of a user, a display area of a product that the user may be interested in can be shown larger or shown in a display form that is more conspicuous than others. At that time, the number of already-read times of each product by a user belonging to the same attribute may be considered. That is, a product that has been read many times by users belonging to the same attribute as that of the user who views the list screen may be shown in a display form that is different from the other products.

Further, as illustrated in FIGS. 4(b), 5, and 6, in the case of displaying already-read products and unread products distinguishably in the list screen, the display may be updated at an arbitrary time. For example, even during the display of the list screen, determination of an already-read state, to be described below, is performed based on the display mode of the products, and already-read processing is executed. At that time, the display means 3 may perform display processing to update the display as soon as the already-read processing is executed, or the display means 3 may update the display collectively at predetermined intervals while already-read processing is performed continuously. Further, the display means 3 may update the display when the product display device 1 receives an instruction of updating the display from a user or update the display when an input of switching the setting between display and non-display of already-read products is received via the already-read switching part W11, W21, or W31.

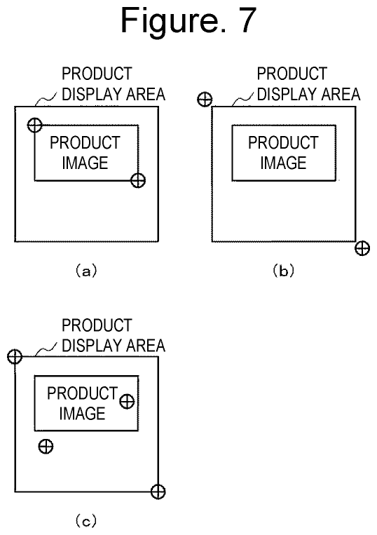

Next, the determination of an already-read state in the present embodiment will be described with reference to FIGS. 7 to 11. In the present embodiment, the already-read processing means 4 determines that the product is already read when a plurality of determination points set in the display area of the product or to the outer periphery of the display area fall in the determination area within the display range of the screen, or they pass through the determination line within the display area of the screen. FIGS. 7(a) to 7(c) illustrate examples of determination points set in the display area of a product for determining an already-read state by the already-read processing means 4 in the present embodiment. Positions and the number of determination points to be set may be determined arbitrarily.

For example, when determination points are set to the outer periphery or at an endpoint of a product image as illustrated in FIG. 7(a), it is possible to operate that the product is determined to be already read when the product image is entirely shown in the determination area described below, for example. Further, when determination points are set to positions of the outer periphery slightly away from the display area of the product as illustrated in FIG. 7 (b), it is possible to operate that the product is determined to be already read when the display area of the product is shown at a position near the center of the determination area, for example.

In the present embodiment, the already-read processing means 4 determines that the product is already read when a state where the display area of the product is displayed in the determination area continues a predetermined time or longer, and preferably, the state continues three seconds or longer. Here, in the present embodiment, as a specific portion of the display area of a product, a plurality of determination points are set in the display area of the product or to the outer periphery of the display area, and when the entire determination points fall within the display area, it is determined that the display area of the product is displayed in the determination area. That is, in the present embodiment, when a state where the entire determination points fall within the display area continues a predetermined time or longer, the product is determined to be already read.

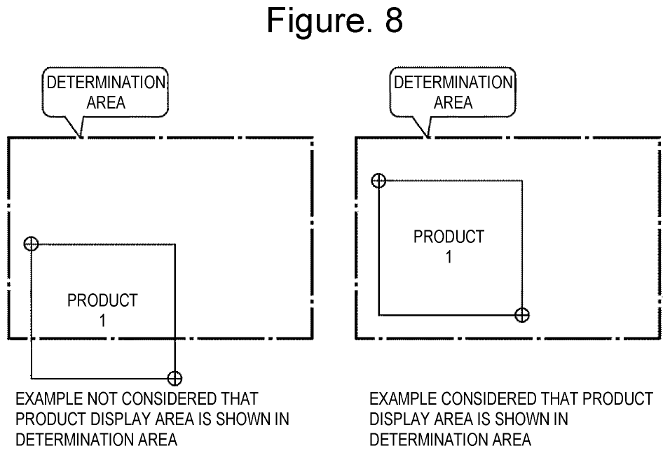

FIG. 8 illustrates examples of determination when the determination of an already-read state is performed using the determination area. In the present embodiment, it is determined that the display area of a product is shown in the determination area when the entire determination points simultaneously fall within the determination area, as described above. In the example on the left side of FIG. 8, it is not determined that the display area of the product is shown in the determination area, while in the example on the right side of FIG. 8, it is determined that the display area of the product is shown in the determination area.

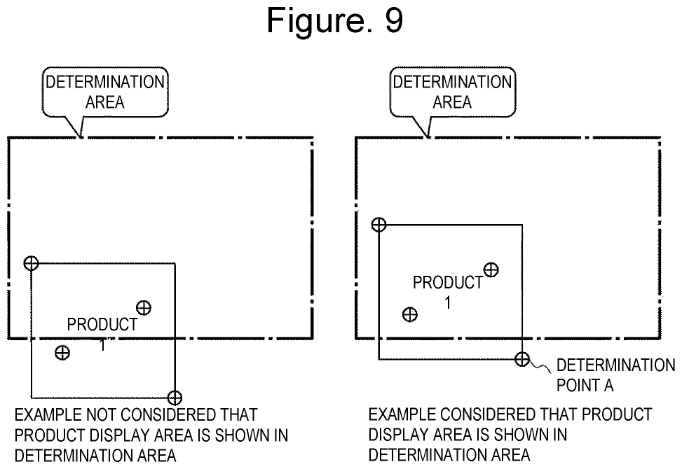

Note that even if the entire determination points do not fall within the display area, the already-read processing means 4 may determine that the display area of a product is shown in the determination area when a predetermined percentage or the predetermined number of determination points, among a plurality of determination points set in the display area or to the outer periphery of the display area of the product, simultaneously fall within the determination area. FIG. 9 is referred to based on the assumption that the display area of a product is determined to be shown in the determination area when three out of four determination points fall within the determination area. In this case, since only two determination points fall within the determination region in the left-side example, it is not determined that the display area of the product is shown in the determination area. However, since three determination points simultaneously fall within the determination area in the right-side example, it is determined that the display area of the product is shown in the determination area.

Further, when determining an already-read state, for each of the determination points, the already-read processing means 4 may further consider the continuing time of a state where each determination point is in the determination area. For example, although a state where the entire determination points of a product fall within the determination area simultaneously does not continue a predetermined time, there is a case where each of the determination points falls within the determination area a predetermined time or longer continuously. In such a case, the already-read processing means 4 may determine that the product is already read.

More specifically, in the case of performing determination of an already-read state based on the premise that the entire determination points fall within the determination area, for example, it is assumed that the state of the right-side example in FIG. 9 continues a predetermined time, and then a determination point A falls within the determination area and is shown in the determination area a predetermined time, but the state where the entire determination points fall within the determination area simultaneously is not continued a predetermined time and another determination point leaves the determination area. Even in such a case, the already-read processing means 4 may determine that the product is already read. That is, the already-read processing means 4 may consider that the display area of a product is shown in the determination area when a state where each of the determination points of the product falls within the determination area continues a predetermined time or longer, and determine that the product is already read.

In the above description, it has been explained that the processing of determining that the product is already read by the already-read processing means 4, when a state where the display area of a product is shown in the determination area continues a predetermined time or longer. Meanwhile, instead of the determination area, it is also possible to set a determination line in the display area of the product, and when the display area of the product passes through the determination line in a direction toward the center of the display range of the screen by the scrolling operation or the like, the already-read processing means 4 may determine that the product is already read. The setting position, angle, and the number of the determination lines may be determined arbitrarily.

Moreover, when a specific portion of the display area of a product, that is, a determination point in particular, passes through the determination line in a direction toward the center of the display range of the screen, the already-read processing means 4 may consider that the display area of the product passes through the determination line to determine that the product is already read. Even in that case, the already-read processing means 4 may determine that the display area of the product passes through the determination line when the entire determination points pass through the determination line as similar to the case of determining an already-read state using the determination area, or may determine that the display area of the product is shown in the determination area when a predetermined percentage or the predetermined number of determination points, among a plurality of determination points, pass through the determination line.

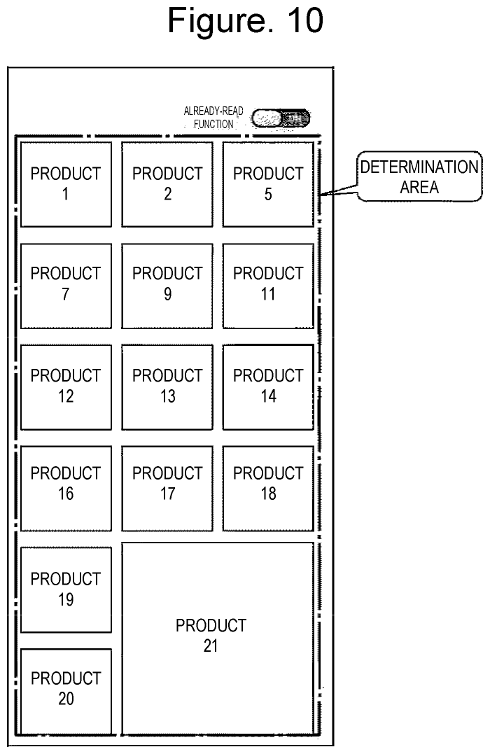

FIG. 10 illustrates an exemplary setting of a determination area in the present embodiment. When a determination area is set throughout the display range of the screen, a product whose display area is shown in the determination area is determined to be already read regardless of the position on the screen.

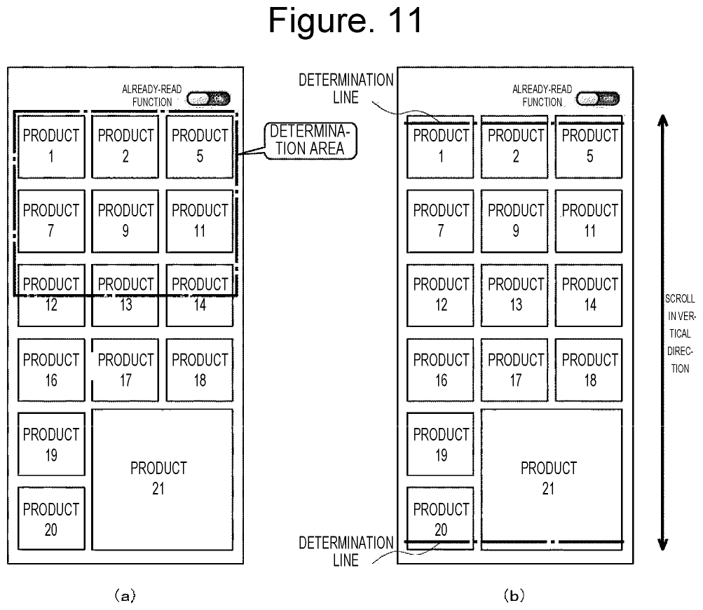

Further, as illustrated in FIG. 11(a), a determination area may be set in the part of the display range of the screen. For example, when a determination area is set at a position where a user can easily pay attention to the screen, it is possible for the already-read processing means 4 to accurately determine an already-read state of a product having a higher possibility of being checked by the user.

On the other hand, FIG. 11(b) illustrates an exemplary set of determination lines in the display range on the screen. The setting of such determination lines is effective when the list screen is moved by scrolling in the vertical direction. By setting determination lines in a horizontal direction at both the top and bottom end of the display range on the screen in this way, it is possible to detect that the display area (in particular, determination points) of a product falls within or leaves the display area on the screen.

When the already-read determination is performed by means of a method as described above, the already-read processing means 4 executes already-read processing for storing an already-read state by a user. In the present embodiment, as already-read processing, the already-read processing means 4 stores already-read information in which a product determined to be already read and the user are associated with each other, in the storage means of the product display device 1. Then, the already-read processing means 4 transmits the already-read information stored in the storage means of the product display device 1 to the server device 2 or the database DB at arbitrary timing, whereby the already-read information specifies the user and the product is stored in the database DB.

Then, the display means 3 performs display processing according to the already-read information stored in the storage means of the product display device 1 or the already-read information transmitted from the server device 2 or the database DB, whereby a list screen in which the already-read products and unread products are distinguished from each other is shown on the display of the product display device 1. By updating the display at arbitrary timing, a user can view the products efficiently while recognizing already-read products and unread products.

In particular, when a user checks new arrival products a plurality of times under the same search condition or tries to find an intended product by changing the search condition, it is possible to distinguish products having been shown on the list screen (already read) in the previous search result. Therefore, in addition to the fact that a user can view the products efficiently, a processing load reducing effect due to a decrease in the number of searches can also be expected.

Note that already-read flags to be stored and the number of already-read times may be reset when a predetermined period passed.

### REFERENCE SIGNS LIST

1: the product display device
2: server device
3: display means
4: already-read processing means
5: switching means
NW: network
W11: already-read switching part
W12: menu display part
W13: product display part
W14: display area
W21: already-read switching part
W22: already-read product display part
W31: already-read switching part

1. A product display device for displaying a plurality of products side by side on the same screen, the device comprising:
means for performing display processing on product information to display a list screen of the plurality of products, the list screen being viewable by scrolling to move a display range;
means for executing already-read processing for recording an already-read state by a user for a product determined to be already read among the plurality of products included in the list screen, the product being determined to be already read because of being shown in the display range; and
means for performing display processing on the product information of an unread product in order not to display an already-read product determined to be already read and in order to display the list screen consisting of the unread product not determined to be already read.

2. The product display device according to claim 1, wherein:
means for receiving, from the user, and setting selection of display or non-display on the list screen of the already-read product determined to be already read; and
means for performing display processing on the product information of an unread product in order to display the list screen consisting of the unread product not determined to be already read when the non-display of the already-read product is set, while performing display processing on the product information in order to display the already-read product and the unread product distinguishably on the list screen when the display of the already-read product is set.

3. The product display device according to claim 1, wherein
the product is determined to be already read when a display area of the product is shown in a determination area within a display range on a screen.

4. The product display device according to claim 3, wherein
the product is determined to be already read when a state where the display area of the product is shown in the determination area continues a predetermined time or longer.

5. The product display device according to claim 3, wherein
the display area of the product is considered to be shown in the determination area when a specific portion of the display area of the product falls within the determination area.

6. The product display device according to claim 3, wherein
the display area of the product is considered to be shown in the determination area when, among a plurality of determination points set in the display area of the product or an outer periphery of the display area, a predetermined percentage of the determination points simultaneously fall within the determination area.

7. The product display device according to claim 6, wherein
the display area of the product is considered to be shown in the determination area when all of the plurality of determination points of the product fall within the determination area.

8. The product display device according to claim 6, wherein
the display area of the product is considered to be shown in the determination area when a state where each of the all of the plurality of determination points of the product falls within the determination area continues a predetermined time or longer.

9. The product display device according to claim 1, wherein
the product is determined to be already read when a display area of the product passes through a determination line in the display range on a screen.

10. The product display device according to claim 9, wherein
the display area of the product is considered to pass through the determination line when the display area of the product passes through the determination line in a direction toward the center of the display range on the screen.

11. The product display device according to claim 9, wherein
the display area of the product is considered to pass through the determination line and determined to be already read when a specific portion of the display area of the product passes through the determination line.

12. A non-transitory readable medium stores product display program for displaying a plurality of products side by side on the same screen, the program causing a computer to function as:
means for performing display processing on product information to display a list screen of the plurality of products, the list screen being viewable by scrolling to move a display range;
means for executing already-read processing for recording an already-read state by a user for a product determined to be already read among the plurality of products included in the list screen, the product being determined to be already read because of being shown in the display range; and
means for performing display processing on the product information of an unread product in order not to display an already-read product determined to be already read and in order to display the list screen consisting of the unread product not determined to be already read.

13. The non-transitory readable medium stores according to claim 12, wherein:
means for receiving, from the user, and setting selection of display or non-display on the list screen of the already-read product determined to be already read; and
means for performing display processing on the product information of an unread product in order to display the list screen consisting of the unread product not determined to be already read when the non-display of the already-read product is set, while performing display processing on the product information in order to display the already-read product and the unread product distinguishably on the list screen when the display of the already-read product is set.

14. A product display method for displaying a plurality of products side by side on the same screen, the method causing a computer to perform the steps of:
performing display processing on product information to display a list screen of the plurality of products, the list screen being viewable by scrolling to move a display range;
executing already-read processing for recording an already-read state by a user for a product determined to be already read among the plurality of products included in the list screen, the product being determined to be already read because of being shown in the display range; and
performing display processing on the product information of an unread product in order not to display an already-read product determined to be already read and in order to display the list screen consisting of the unread product determined to be already read.

15. The product display method according to claim 14, wherein;
receiving, from the user, and setting selection of display or non-display on the list screen of the already-read product determined to be already read; and
performing display processing on the product information of an unread product in order to display the list screen consisting of the unread product not determined to be already read when the non-display of the already-read product is set, while performing display processing on the product information in order to display the already-read product and the unread product distinguishably on the list screen when the display of the already-read product is set.
